(19) United States
(12) Patent Application Publication
(10) Pub. No.: US 2020/0247162 A1
(43) Pub. Date: Aug. 6, 2020

(54) IMAGE FORMING APPARATUS

(71) Applicant: Oki Data Corporation, Tokyo (JP)

(72) Inventor: Yusuke HENMI, Tokyo (JP)

(21) Appl. No.: 16/720,335

(22) Filed: Dec. 19, 2019

(30) Foreign Application Priority Data
Feb. 6, 2019 (JP) 2019-019485

(51) Int. Cl. B41J 29/393; B41J 11/00; B41J 2/21

(52) U.S. Cl. CPC B41J 29/393; B41J 2/2142; B41J 2/2135; B41J 11/0095

(57) ABSTRACT

An image forming apparatus includes (a) recording heads that are mounted on a carriage, (b) a pattern image formation processing part that forms a test pattern image on a recording medium at a pattern image formation position, (c) an optical detection part that emits light onto the recording medium, receives reflection light, and generates a sensor output in correspondence with the reflection light, (d) a pattern image detection processing part that detects the test pattern image at the pattern image formation position, generating a detection result, (e) an image forming condition setting part that sets an image forming condition based on the detection result of the test pattern image, and (f) dense parts and pale parts are alternately formed in the test pattern image.

### TECHNICAL FIELD

This invention relates to an image forming apparatus, mainly an ink jet printer.

### BACKGROUND

Conventionally, in an image forming apparatus such as a printer, copier, facsimile machine, or multifunction peripheral, for example in an inkjet printer, printing is performed by having a carriage reciprocate along a rail, a recording medium carried, and inks ejected from recording heads mounted on the carriage and adhere to the recording medium, thereby forming an image.

In this kind of inkjet printer, in order to form an image, dots need to be formed in the same position between the outbound and inbound travels of the carriage. For that purpose, an image of a test pattern, that is, a pattern image is formed on the recording medium, the pattern image is detected by an optical sensor, and timing to eject inks from the recording heads is adjusted based on a sensor output of the optical sensor that is a detection result of the pattern image.

In this case, reflection light of light emitted toward the pattern image from a light emitting part of the optical sensor is received on a light receiving part of the optical sensor, and based on a detection voltage as the sensor output generated by the light receiving part, a correction value for adjusting the timing to eject inks is calculated.

### RELATED ART

[Patent Doc. 1] JP Laid-Open Patent Application Publication 2014-111326

However, in the above-mentioned conventional inkjet printer, if the pattern image is formed on the recording surface of the recording medium where a plurality of thin white streaks extending in the sub scanning direction are formed, the longitudinal lines of the pattern image and the streaks of the recording surface interfere with each other, making the sensor output of the optical sensor unstable, thereby the pattern image cannot be accurately detected.

For example, depending on the position where the pattern image is formed, the streaks of the recording surface may be excessively exposed on test patches constituting the pattern image, in which case the detection voltage generated by the light receiving part becomes low.

Therefore, the timing to eject developer, which is inks or tonner, from the recording heads cannot be accurately adjusted, degrading the image quality.

The objective of this invention is to solve the above-mentioned problem of the conventional printer and thereby offer an image forming apparatus that can accurately detect the test pattern image and accurately adjust the timing to eject the developer from the recording heads, improving the image quality.

### SUMMARY

An image forming apparatus, disclosed in the application, includes (a) recording heads that are mounted on a carriage, (b) a pattern image formation processing part that forms a test pattern image on a recording medium by using the recording heads, wherein a position of the test pattern on the recording medium is defined as a pattern image formation position, (c) an optical detection part that emits light onto the recording medium, receives reflection light that is reflected on the recording medium, and generates a sensor output in correspondence with the reflection light, (d) a pattern image detection processing part that detects the test pattern image formed at the pattern image formation position using the optical detection part, generating a detection result, and (e) an image forming condition setting part that sets an image forming condition based on the detection result of the test pattern image.

Dense parts and pale parts are alternately formed in the test pattern image.

According to one embodiment of this invention, the image forming apparatus is provided with a carriage arranged freely movable in the main scanning direction, recording heads mounted on the carriage, a carriage drive processing part that moves the carriage by driving a drive part for moving the carriage, a pattern image formation processing part that drives the above-mentioned recording heads to form the test pattern image on the recording medium, an optical detection part that emits light according to the movement of the above-mentioned carriage, receives reflection light, and generates the sensor output, a pattern image detection processing part that detects the test pattern image formed on a pattern image formation position by the optical detection part, and an image forming condition setting part that sets an image forming condition based on the detection result of the test pattern image.

Then, dense parts and pale parts are alternately formed in the above-mentioned test pattern image.

In this case, because the dense parts and the pale parts are alternately formed in the test pattern image, the dense parts do not excessively cover the streaks formed on the recording surface of the recording medium, or the above-mentioned streaks are not excessively exposed. Therefore, the sensor output of the optical detection part becomes stable, thereby the pattern image can be accurately detected.

As a result, timing to eject inks from recording heads can be accurately adjusted, allowing to improve the image quality.

### BRIEF DESCRIPTIONS OF THE DRAWINGS

FIG. 1 is a control block diagram of an inkjet printer in an embodiment of this invention.

FIG. 2 is a perspective view showing the main part of the inkjet printer in the embodiment of this invention.

FIG. 3 is a cross-sectional view of a retroreflective medium in the embodiment of this invention.

FIG. 4 is a diagram showing the recording surface of the retroreflective medium in the embodiment of this invention.

FIG. 5 is a diagram showing a sensor output when light is emitted onto the recording medium in the embodiment of this invention.

FIG. 6 is a diagram showing an example sensor output of an optical sensor when the pattern image is formed on the recording medium made of the retroreflective medium.

FIG. 7 is a diagram showing a basic pattern image in the embodiment of this invention.

FIG. 8 is a diagram showing a reference pattern image in the embodiment of this invention.

FIG. 9 is a diagram showing a comparison pattern image in the embodiment of this invention.

FIG. 10 is a flow chart showing the operations of the inkjet printer in the embodiment of this invention.

FIG. 11 is a diagram showing the relationship between the recording surface of the recording medium and a test patch in the embodiment of this invention.

FIG. 12 is the first diagram showing another example of the basic pattern image in the embodiment of this invention.

FIG. 13 is the second diagram showing another example of the basic pattern image in the embodiment of this invention.

FIG. 14 is the third diagram showing another example of the basic pattern image in the embodiment of this invention.

### DETAILED DESCRIPTIONS OF THE PREFERRED EMBODIMENT(S)

Below, detailed explanations are given on an embodiment of this invention referring to drawings. In this case, the explanations are given on an inkjet printer as an image forming apparatus.

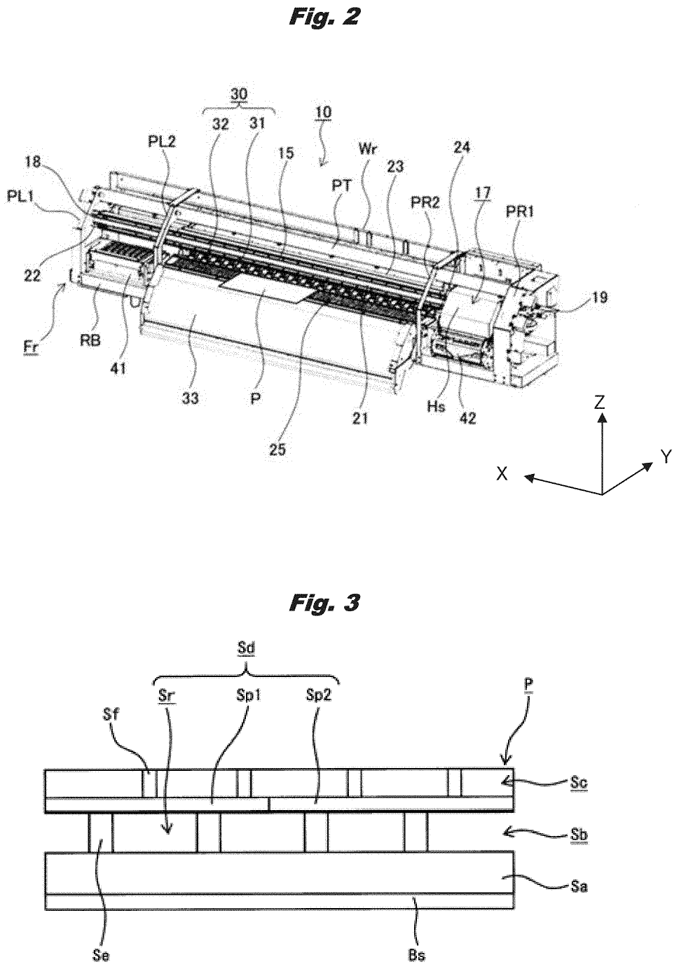

FIG. 2 is a perspective view showing the main part of the inkjet printer in the embodiment of this invention.

In the figure, indicated as 10 is the inkjet printer, Fr is a frame of the inkjet printer 10.

The frame Fr is provided with a receiving plate RB arranged extending from the left end to the right end when the main body of the inkjet printer 10, that is, the apparatus main body is viewed from its front side (front side in the figure), a side plate PL1 as a first main frame formed standing up from the left end of the receiving plate RB, a side plate PR1 as a second main frame formed standing up from the right end of the receiving plate RB, a frame body PL2 as a first sub frame formed standing up from the receiving plate RB at a prescribed rightward distance from the side plate PL1, a frame body PR2 as a second sub frame formed standing up from the receiving plate RB at a prescribed leftward distance from the side plate PR1, a rear wall Wr that connects the side plates PL1 and PR1 and the frame bodies PL2 and PR2 on the rear face of the inkjet printer 10, an upper plate PT that connects the upper ends of the side plates PL1 and PR1 and the frame bodies PL2 and PR2, etc.

A rail 15 is arranged (stretched) between the side plates PL1 and PR1, and a carriage 17 is arranged along the rail 15 in a freely movable manner in the left-right direction, that is, the main scanning direction. For that purpose, arranged in a freely rotatable manner are a drive-side pulley 18 on the side plate PL1 and a driven-side pulley 19 on the side plate PR1, an endless belt 21 is stretched in a freely travelable manner by the drive-side pulley 18 and the driven-side pulley 19, and the carriage 17 is attached to a prescribed place of the endless belt 21.

Inside the carriage 17, a plurality of (four in this embodiment) recording heads Hdi (i=1, 2, . . . , 4) mentioned below (FIG. 3) are arranged with their nozzle faces oriented downwards so as to allow forming at least one image. Also, a carriage motor 22 as a drive part for moving the carriage is arranged adjacent to the drive-side pulley 18. Also, an optical sensor 24 as an optical detection part is arranged on the side face in the side plate PL1 side of a housing Hs of the carriage 17.

In this embodiment, the recording heads Hdi eject inks of black, cyan, magenta, and yellow colors, respectively.

Each of the recording heads Hdi has a width of 2 inches with respect to a sub scanning direction and is provided with a nozzle array comprising 1024 nozzles in the sub scanning direction. Accordingly, it can form up to 1024 dots with a pitch of about 49.6 μm.

By driving the above-mentioned carriage motor 22, the above-mentioned drive-side pulley 18 is rotated to have the endless belt 21 travel, thereby the carriage 17 is moved in the main scanning direction, and the recording heads Hdi are moved in the main scanning direction (±X directions, see FIG. 2).

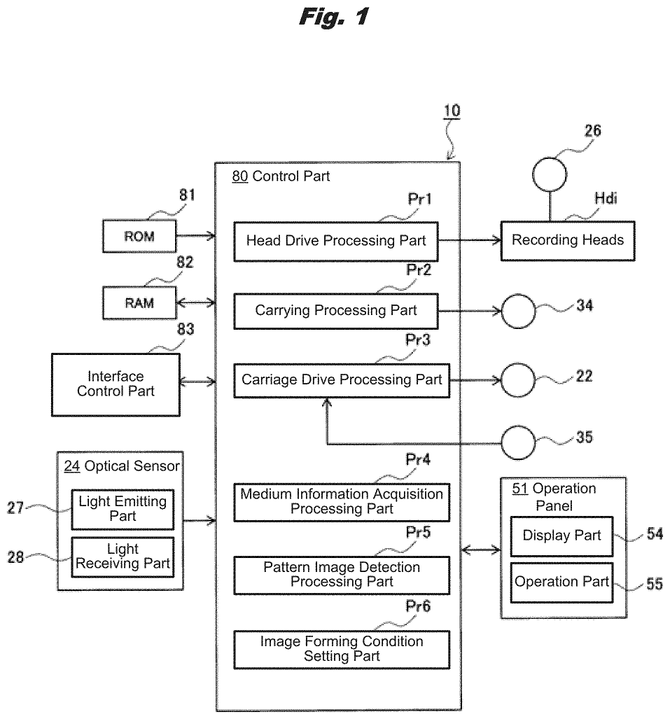

A linear scale 23 is arranged extending along the above-mentioned rail 15 and in parallel to the rail 15, and a below-mentioned encoder 35 arranged on the carriage 17 reads graduations of the linear scale 23, thereby detecting the position of the carriage 17. A sensor output of the encoder 35 is A/D converted into a position signal, a carriage drive processing part Pr3 of a below-mentioned control part 80 (FIG. 1) reads the position signal, calculates the position and moving speed of the carriage 17, and moves the carriage 17.

At this time, according to the position of the carriage 17, color inks are ejected from the recording heads Hdi toward a recording medium P and adhere to the recording medium P, thereby forming an image such as a character or picture on the recording medium P.

In this manner, recording by the recording heads Hdi, that is, printing is performed.

Note that as the recording medium P, other than a sheet of paper, a film made of resin such as vinyl chloride or PET can be used.

Also, a platen 25 having a plate shape is arranged extending along the above-mentioned rail 15 and in parallel to the rail 15, that is, in the main scanning direction. The platen 25 extends between the frame bodies PL2 and PR2 on the above-mentioned receiving plate RB and supports the recording medium P carried on the platen 25.

Then, arranged under the above-mentioned platen 25 is an unshown air suction device for drawing the recording medium P toward the platen 25 with a negative pressure. The air suction device is formed over the entire area under the platen 25 and comprises a suction chamber, a suction fan, etc., and air above the platen 25 is sucked through a plurality of holes formed on the platen 25 by the suction fan, thereby the recording medium P is supported flat by the platen 25.

Also, arranged toward the back of the platen 25 is an unshown rear paper guide as a first medium guide part, and the rear paper guide guides the recording medium P fed out from an unshown feeding roll toward the platen 25. For that purpose, a carrying roller pair 30 as a carrying member is arranged in a freely rotatable manner between the above-mentioned rear paper guide and the platen 25.

The carrying roller pair 30 comprises a carrying roller 31 as a first roller arranged adjacent to the platen 25 in a freely rotatable manner extending in the main scanning direction of the inkjet printer 10, and pinch rollers 32 as second rollers that are arranged in a freely rotatable manner in a plurality of places with a prescribed pitch above the carrying roller 31 and press the recording medium P against the carrying roller 31. Once a below-mentioned carrying motor 34 (see FIG. 1) as a carrying drive part is driven to rotate the carrying roller 31, the pinch rollers 32 are rotated following it.

Thereby, the recording medium P is fed out from the above-mentioned feeding roll in a state pinched by the carrying roller 31 and the pinch rollers 32, and sent toward the platen 25 on the above-mentioned rear paper guide. Then, while being carried on the platen 25, the recording medium P opposes the nozzle faces of the recording heads Hdi, and inks are ejected from the recording heads Hdi and adhere to the recording medium P.

In this case, printing is performed by a multi-pass method, where the carrying motor 34 is driven to carry the recording medium P by a prescribed distance, afterwards the carrying motor 34 is stopped, and the carriage 17 is moved in that state, inks are ejected from the recording heads Hdi, thereby one scan is performed, and this operation is repeated multiple times to perform multiple scans, thereby forming one line of an image.

Note that when printing by a single-pass method, the distance to carry the recording medium P mentioned above is set equal to the length of the nozzle array of the recording heads Hdi, and one line of an image is formed by performing one scan.

Also, arranged toward the front of the above-mentioned platen 25 is a front paper guide 33 as a second medium guide part for guiding and ejecting the recording medium P on which printing was performed. The front paper guide 33 has a curved shape for guiding downwards the recording medium P ejected in the horizontal direction from the above-mentioned platen 25.

Therefore, the recording medium P is guided by the above-mentioned rear paper guide and sent to the platen 25, on which printing is performed by having inks ejected from the recording heads Hdi adhere, afterwards is guided by the front paper guide 33 and sent to and wound up by the an unshown winding device arranged on the frame Fr.

Note that the rear paper guide, the platen 25, and the front paper guide 33 mentioned above each has an unshown heater as a heating member embedded, and the recording medium P is preheated by the rear paper guide and heated by the platen 25 and the front paper guide 33, thereby promoting drying of inks adhering to the recording medium P.

In the ink jet printer 10, a home position is set between the above-mentioned side plate PL1 and the above-mentioned frame body PL2, a retreat position is set between the above-mentioned frame body PR2 and the above-mentioned side plate PR1, and the carriage 17 reciprocates between the home position and the retreat position.

Then, arranged in the above-mentioned home position is a cap unit 41 as a first maintenance device comprising a cap that covers the nozzle faces of the recording heads Hdi and prevents drying of inks, an ink receiver that receives inks having developed high viscosity in the nozzles, etc. Also, arranged in the above-mentioned retreat position is a wipe unit 42 as a second maintenance device provided with an unshown wiper that rubs the nozzle faces of the recording heads Hdi and removes dirt, inks, etc. adhering onto the nozzle faces in order to maintain the nozzles of the recording heads Hdi in a good state.

Furthermore, in the inkjet printer 10, an image is formed on the recording medium P while reciprocating the carriage 17 in the in this embodiment. Inks need to be ejected so that, for example, dots are superimposed on each other for the same pixel between the outbound travel (−X direction) that moves the carriage 17 from the home position side to the retreat position side and the inbound travel (+X direction) that moves the carriage 17 from the retreat position side to the home position side.

Then, in this embodiment, the image of a test pattern, that is, a pattern image is formed, the pattern image is detected by the above-mentioned optical sensor 24, and based on a sensor output of the optical sensor 24 that is a result of detecting the pattern image, timings to eject inks from the recording heads Hdi in the outbound and inbound travels of the carriage 17 are adjusted.

Next, explained is a control device of the inkjet printer 10.

FIG. 1 is a control block diagram of the inkjet printer in the embodiment of this invention.

In the figure, indicated as 10 is the inkjet printer, 24 is the optical sensor, 51 is an operation panel, 80 is a control part that controls printing by controlling the whole sequence of the above-mentioned inkjet printer 10, 81 is ROM as a first memory part comprising nonvolatile memory, 82 is RAM as a second memory part comprising volatile memory, and 83 is an interface control part that receives print data from an unshown host computer as an upper-level device and an information processing device and records the data in the above-mentioned RAM 82. Although in this embodiment the print data are received via a USB cable, they can be received via a wireless LAN.

The above-mentioned optical sensor 24 is arranged on the side face in the side plate PL1 side of the housing Hs of the above-mentioned carriage 17 (FIG. 2), and is moved in the main scanning direction according to the movement of the carriage 17. The optical sensor 24 is provided with a light emitting part 27 comprising LEDs or the like, a light receiving part 28 comprising phototransistors or the like, and an unshown sensor driver. The light emitting part 27 emits light onto the recording medium P stopped on the above-mentioned platen 25 with a prescribed sampling cycle based on drive signals by the sensor driver, the light receiving part 28 receives reflection light from the recording medium P, and analog detection signals generated at this time are A/D converted by the above-mentioned sensor driver to become detection voltages.

The above-mentioned operation panel 51 is provided with a display part 54 comprising an LED screen or the like for displaying the state of the inkjet printer 10, and an operation part 55 comprising switches, keys, etc. for the operator to input instructions to the inkjet printer 10. Note that if the operation panel 51 is formed of a touch panel, the display part 54 also functions as the operation part as well as the display part.

Then, the above-mentioned control part 80 is provided with a CPU as an arithmetic device, input/output ports, a timer, etc. that are not shown, and performs various processes based on a program recorded in the ROM 81.

In the ROM 81, other than the above-mentioned program, various types of initial setting values, image data of the pattern image, etc. are recorded. Also, in the RAM 82, other than image data that are generated based on the above-mentioned print data and for performing the normal printing, various types of control data are temporarily recorded. Note that the RAM 82 functions as a work area when the above-mentioned CPU performs arithmetic operations.

Also, the above-mentioned control part 80 is provided with a head drive processing part Pr1 as a pattern image formation processing part, a carrying processing part Pr2, the carriage drive processing part Pr3, a medium information acquisition processing part Pr4, a pattern image detection processing part Pry, an image forming condition setting part Pr6, etc.

Before printing is started, the above-mentioned head drive processing part Pr1 reads image data of the pattern image from the above-mentioned ROM 81, sends them to the recording heads Hdi, and drives the recording heads Hdi to form the pattern image on the recording medium P. Also, once printing is started, the above-mentioned head drive processing part Pr1 reads print data from the above-mentioned RAM 82, converts the print data to generate image data, sends the generated image data to the recording heads Hdi, and drives the recording heads Hdi to form an image on the recording medium P.

Note that arranged on the above-mentioned recording heads Hdi are piezo elements 26 as drive elements for the nozzles, respectively. Once a prescribed voltage is applied between unshown electrodes arranged at both ends of each of the piezo elements 26, the piezo elements 26 are driven to expand or contract according to the voltage, thereby deforming side walls of flow routes to send inks to the nozzles on the recording heads Hdi. Then, by the cross-sectional areas of the ink flow routes change according to the expansion or contraction of the piezo elements 26, inks by the same amounts as the changes in the cross-sectional areas of the ink flow routes are ejected from the nozzles as ink droplets.

The above-mentioned carrying processing part Pr2 sends a drive signal to the carrying motor 34, driving the carrying motor 34, rotating the above-mentioned carrying roller pair 30 (FIG. 2), and carrying the recording medium P in the sub scanning direction.

The above-mentioned carriage drive processing part Pr3 drives the carriage motor 22 by a PWM control to have the above-mentioned endless belt 21 travel and the carriage 17 reciprocate in the main scanning direction.

For that purpose, the carriage drive processing part Pr3 reads a target position and a target speed of the carriage 17 from the ROM 81, reads a sensor output of the encoder 35 mentioned above, A/D converts the sensor output to calculate the position of the carriage 17, generates a PWM control signal as a control value, and sends it to the carriage motor 22. The carriage motor 22 receives the PWM control signal, changes the rotation speed in proportion to the duty of the PWM control signal, and moves the carriage 17 to the target position at the target speed by accelerating or decelerating it.

Also, the carriage drive processing part Pr3 sends the position of the carriage 17 to the head drive processing part Pr1, the head drive processing part Pr1 ejects inks at timings calculated based on the image data according to the position of the carriage 17 from the recording heads Hdi.

In forming the pattern image on the recording medium P, the above-mentioned information acquisition processing part Pr4 detects the position of the recording medium P on the platen 25 and acquires the characteristics of the recording surface of the recording medium P.

The above-mentioned pattern image detection processing part Pr5 detects the pattern image formed on the recording medium P.

The above-mentioned image forming condition setting part Pr6 adjusts the timings to eject inks from the recording heads Hdi based on the detection result of the pattern image. For example, the printer head ejects inks at the same timing as one test patch that has the highest detection voltage among test patches.

By the way, reflection characteristics may vary according to the position on the recording surface due to the materials, structure, etc. of the recording medium P. For example, if a prism-type retroreflective medium is used as the recording medium P, when light is emitted onto the recording surface of the recording medium P, depending on the reflection characteristics of the recording surface, other than a plurality of thin white streaks extending longitudinally (in the sub scanning direction) (hereafter called “longitudinal streaks”), a plurality of thin white streaks extending in an oblique direction (in a direction inclined by ±45° relative to the sub scanning direction) (hereafter called “slant streaks”) are formed.

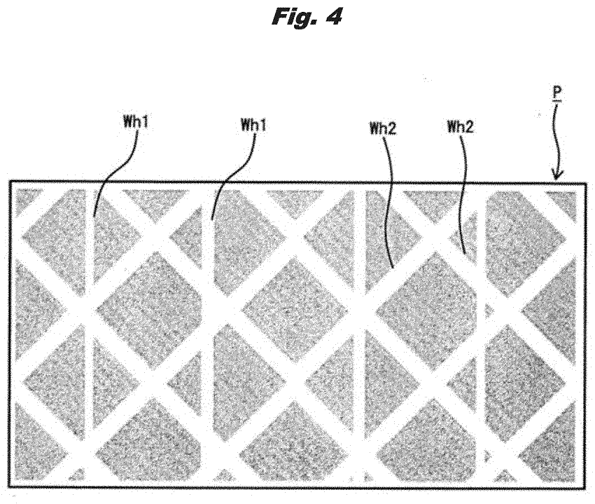

FIG. 3 is a cross-sectional view of the retroreflective medium in the embodiment of this invention, and FIG. 4 is a diagram showing the recording surface of the retroreflective medium in the embodiment of this invention.

In the figure, indicated as P is the recording medium made of the retroreflective medium, Bs is a supporting body, Sa is a base layer, Sb is an intermediate layer, and Sc is a film layer (surface layer).

The above-mentioned intermediate layer Sb is provided with a reflective layer Sd consisting of a prism layer Sp1 as a first refractive layer comprising a plurality of unshown laterally-long prisms, a prism layer Sp2 as a second refractive layer comprising a plurality of unshown longitudinally-long prisms, and an air layer Sr formed below the prism layers Sp1 and Sp2, and supporting layers (binding agent layers) Se that maintain the thickness of the above-mentioned air layer Sr and divide the air layer Sr.

Also, the above-mentioned film layer Sc is provided with supporting bodies Sf that maintain the thickness of the film layer Sc and divide the film layer Sc.

In the recording medium P made of the retroreflective medium mentioned above, if light is incident to a part corresponding to the reflective layer Sd, light is emitted in the opposite direction of the incidence. As opposed to this, if light is incident to a part corresponding to the above-mentioned supporting layers Se, the boundary between the prism layers Sp1 and Sp2, or the supporting bodies Sf, light is specularly or diffusely reflected, and the reflection light is emitted in various directions.

As a result, formed are longitudinal streaks Wh1 on parts corresponding to the supporting layers Se and the supporting bodies Sf, and slant streaks Wh2 on a part corresponding to the prism boundary.

Furthermore, in the recording medium made of the retroreflective medium mentioned above, when light is incident, the longitudinal streaks are formed over the whole part corresponding to the prism layer Sp1 according to differences in reflection characteristics between the prism layers Sp1 and Sp2.

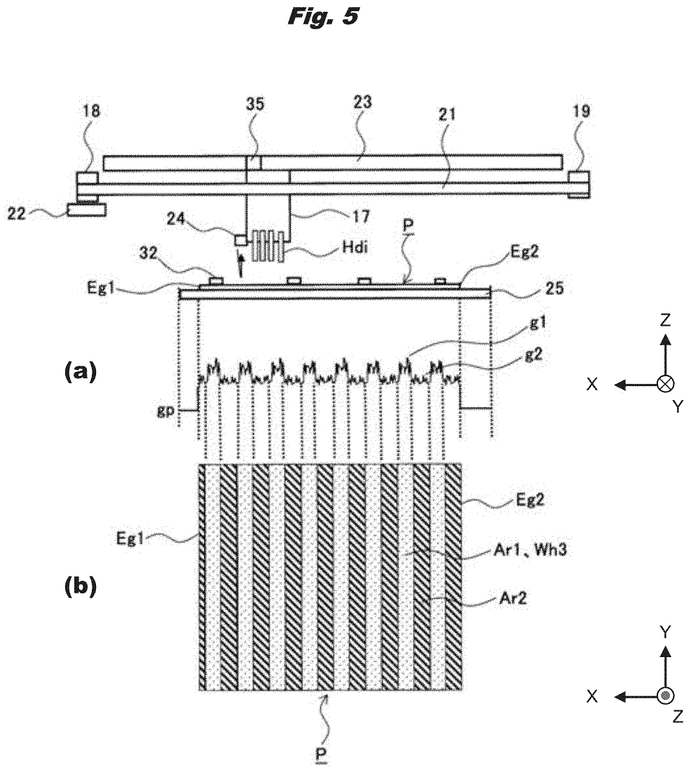

FIG. 5 is a diagram showing the sensor output when light is emitted onto the recording medium in the embodiment of this invention.

In the figure, indicated as P is the recording medium made of the retroreflective medium, Eg1 is an edge part in the home position side of the recording medium P, Eg2 is an edge part in the retreat position side of the recording medium P, 17 is the carriage, Hdi are the recording heads, 18 and 19 are the pulleys, 21 is the endless belt, 22 is the carriage motor, 23 is a linear scale, 24 is the optical sensor, 25 is a platen, 32 are pinch rollers, and 35 is an encoder.

When light is emitted onto the recording medium P, light is incident to the above-mentioned reflective layer Sd, refracted inside the prism layer Sp1 or Sp2, and emitted in the opposite direction of the incidence. A part corresponding to the prism layer Sp1 and a part corresponding to the prism layer Sp2 have different reflection characteristics, that is, different reflection angles by several to 15 degrees, thereby formed alternately in the main scanning direction are band-shaped bright parts, that is bright parts Ar1, as a first region extending in the sub scanning direction on the part corresponding to the prism layer Sp1 on the recording surface, and band-shaped dark parts, that is dark parts Ar2, as a second region extending in the sub scanning direction.

If the reflection light is reflected by the platen 25, the detection voltage of the sensor output of the optical sensor 24 mentioned above becomes a value gp, and if the reflection light is reflected by the recording medium P, it becomes nearly a value g1 on the bright parts Ar1, and nearly a value g2 on the dark parts Ar2, where the values gp, g1, and g2 have a relationship of

g1>g2>gp.

Therefore, on the recording medium P made of the retroreflective medium, longitudinal streaks Wh3 are formed on the bright parts Ar1 of the recording surface mentioned above.

By the way, if the pattern image consisting of a plurality of longitudinal lines is formed on the recording medium P made of the retroreflective medium where the longitudinal streaks Wh1 and Wh3 are formed on the recording surface, the longitudinal streaks Wh1 and Wh3 and the longitudinal lines of the pattern image on the recording surface interfere with each other, making the sensor output of the optical sensor 24 unstable, thereby the pattern image cannot be accurately detected.

Next, explained is the sensor output when light is emitted onto the recording medium P made of the retroreflective medium.

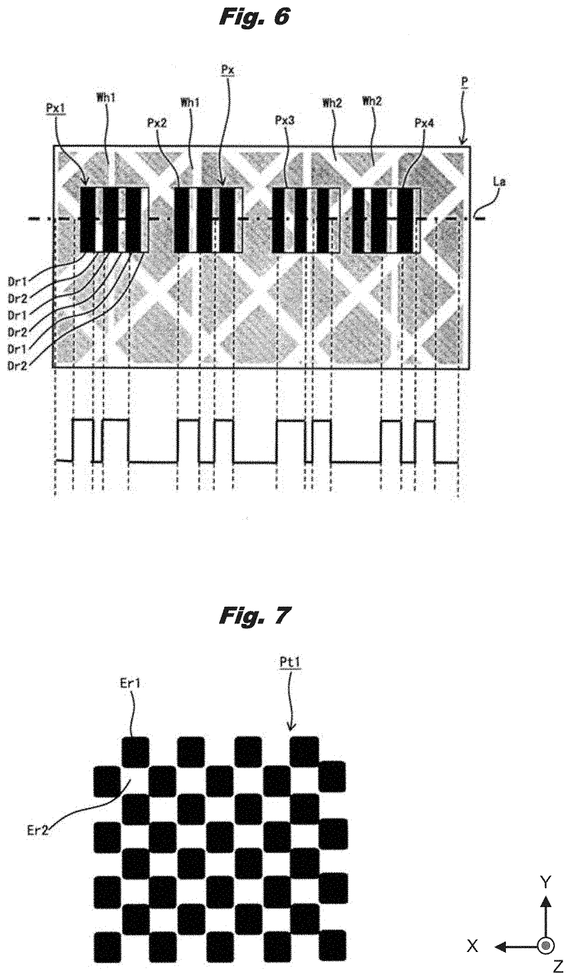

FIG. 6 is a diagram showing an example of the sensor output of the optical sensor when the pattern image is formed on the recording medium made of the retroreflective medium.

In the figure, indicated as P is the recording medium made of the retroreflective medium, Wh1 are the longitudinal streaks, Wh2 are the slant streaks, and Px is the pattern image.

In this case, the pattern image Px consists of test patches Px1-Px4, and each of the test patches Px1-Px4 consists of image regions Da formed by ejecting inks and non-image regions Dr2 formed by not ejecting any ink, where a plurality of longitudinal lines are formed by the image regions Dr1.

When the carriage 17 (FIG. 2) is moved in the main scanning direction, and light is emitted by the optical sensor 24 onto a place indicated with a one-dot chain line La, on the test patches Px1 and Px3, the longitudinal streaks Wh1 and the slant streaks Wh2 are excessively covered with the image regions Dr1, increasing the average value of the detection voltages, and on the test patches Px2 and Px4, the longitudinal streaks Wh1 and the slant streaks Wh2 are excessively exposed, decreasing the average value of the detection voltages.

On the test patches Px1-Px4, based on the occupancy ratio of the image regions Dr1, the average value of the detection voltages should become the lowest on the test patch Px3, it actually becomes higher than the average value of the detection voltages on the test patch Px2 or Px4.

Therefore, the pattern image Px cannot be accurately detected.

Then, in this embodiment, the pattern image is formed by alternately placing the image regions and the non-image regions adjacent to each other in the main scanning direction and the sub scanning direction.

Next, explained is the pattern image. Note that because the timings to eject inks from the recording heads Hdi need to be adjusted, individual color pattern images are formed for the respective recording heads Hdi.

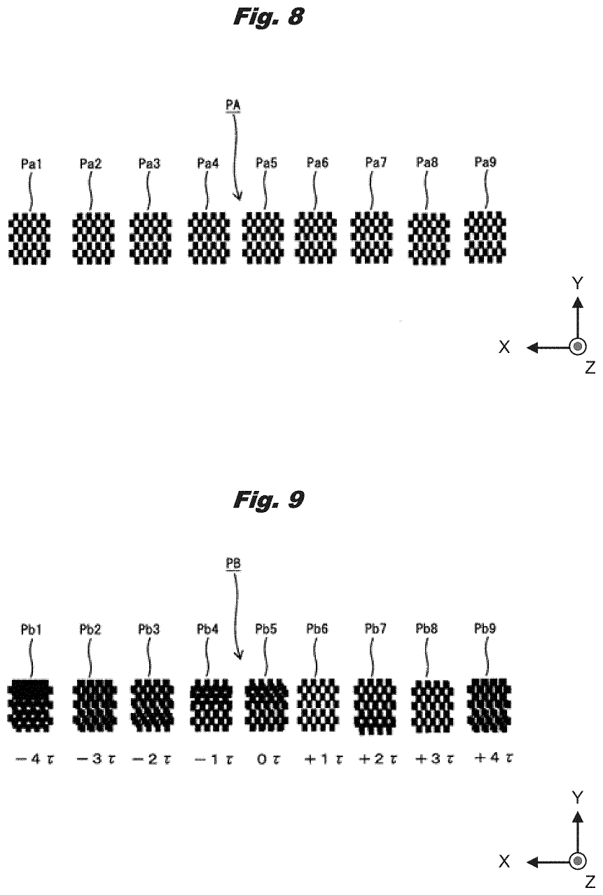

FIG. 7 is a diagram showing a basic pattern image in the embodiment of this invention, FIG. 8 is a diagram showing a reference pattern image in the embodiment of this invention, and FIG. 9 is a diagram showing a comparison pattern image in the embodiment of this invention,

In the figure, indicated as Pt1 is the basic pattern image made of a checkered pattern, PA is the reference pattern image as a first pattern image created based on the basic pattern image Pt1, and PB is the comparison pattern image as a second pattern image created based on the reference pattern image PA.

The above-mentioned basic pattern image Pt1 consists of image regions Er1 as dense parts having a rectangular shape arranged with specific intervals so as to form a plurality of rows and columns, 8 rows and 9 columns in this embodiment, and non-image regions Er2 as pale parts having a rectangular shape arranged with specific intervals so as to form a plurality of rows and columns, 8 rows and 9 columns in this embodiment. The above-mentioned image regions Er1 are formed by ejecting inks, and the above-mentioned non-image regions Er2 are formed by not ejecting any ink, where the image regions Er1 and the non-image regions Er2 are alternately arranged adjacent to each other.

The above-mentioned basic pattern image Pt1 is given longitudinal and lateral dimensions of 10-20 mm and formed by forming 10-20 dot columns and dot rows, each of which has a width of 0.5-1.5 mm, in the sub scanning direction and the main scanning direction in each of the image regions Er1.

Note that various kinds of the above-mentioned basic pattern image Pt1 are created according to the situations of the inkjet printer 10, for example the kinds of the recording medium P used, and are recorded in the ROM 81.

Also, the reference pattern image PA consists of test patches Paj (i=1, 2, . . . , 9) formed in a plurality of places, 9 places in this embodiment, in the main scanning direction, and the test patches Paj are formed by repeatedly forming the basic pattern image Pt1 in the outbound travel of the carriage 17.

Then, the comparison pattern image PB consists of test patches Pbj (j=1, 2, . . . , 9) formed in a plurality of places, 9 places in this embodiment, in the main scanning direction, and the test patches Pbj are formed by superimposing the basic pattern images Pt1 on the test patches Paj of the reference pattern image PA formed in the outbound travel of the carriage 17 with slightly shifted printing timings in the inbound travel of the carriage 17.

For example, inks are ejected at a first timing set as the initial value in the outbound travel of the carriage 17 to form the test patch Pa1, and inks are ejected at a second timing that is later by time 4τ than the first timing in the inbound travel of the carriage 17 to superimpose the basic pattern image Pt1 on the test patch Pa1, thereby forming the test patch Pb1.

In this embodiment, time T is set to time for forming one dot by moving the carriage 17 in the main scanning direction. Therefore, the above-mentioned test patch Pb1 is formed of the basic pattern image Pt1 formed at the first timing and the basic pattern image Pt1 formed at the second timing shifted by 4 dots.

In the same manner, in the inbound travel of the carriage 17, inks are ejected onto the test patch Pa2 at a second timing that is later by time 3τ than the first timing to superimpose the basic pattern image Pt1 shifted by 3 dots, thereby forming the test patch Pb2, inks are ejected onto the test patch Pa3 at a second timing that is later by time 2T than the first timing to superimpose the basic pattern image Pt1 shifted by 2 dots, thereby forming the test patch Pb3, inks are ejected onto the test patch Pa4 at a second timing that is later by 1τ than the first timing to superimpose the basic pattern image Pt1 shifted by 1 dot, thereby forming the test patch Pb4, and inks are ejected onto the test patch Pa5 at the same timing as the first timing to superimpose the basic pattern image Pt1, thereby forming the test patch Pb5.

Also, inks are ejected at a second timing that is earlier by time 1τ than the first timing to superimpose the basic pattern image Pt1 on the test patch Pa6 shifted by 1 dot, thereby forming the test patch Pb6, inks are ejected at a second timing that is earlier by time 2τ than the first timing to superimpose the basic pattern image Pt1 on the test patch Pa1 shifted by 2 dots, thereby forming the test patch Pb7, inks are ejected at a second timing that is earlier by time 3τ than the first timing to superimpose the basic pattern image Pt1 on the test patch Pa8 shifted by 3 dots, thereby forming the test patch Pb8, and inks are ejected at a second timing that is earlier by time 4τ than the first timing to superimpose the basic pattern image Pt1 on the test patch Pa9 shifted by 4 dots, thereby forming the test patch Pb9.

After creating the comparison pattern image PB in this manner, as the widths of the image regions Er1 of the test patches Pbj are compared, it becomes evident that dots are formed in the same position between the outbound and inbound travels of the carriage 17 if inks are ejected at the first and second timings when the test patch Pb6 comprising the narrowest image regions Er1 was formed.

Next, explained are the operations of the inkjet printer 10.

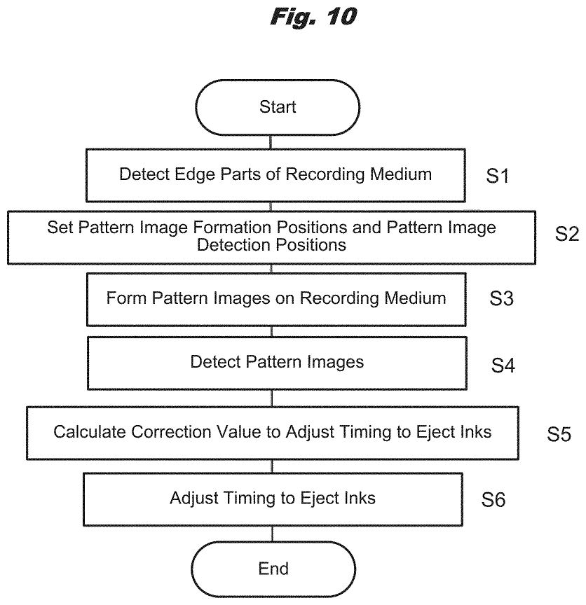

FIG. 10 is a flow chart showing the operations of the inkjet printer in the embodiment of this invention.

First, the carrying processing part Pr2 (FIG. 1) drives the carrying motor 34 to feed out the recording medium P from the feeding roll, send it to the platen 25, and stop it on the platen 25.

Next, the medium information acquisition procession part Pr4 sends an instruction to the carriage drive processing part Pr3 to drive the carriage motor 22, thereby moving the carriage 17 from the home position side to the retreat position side in its outbound travel, has the light emitting part 27 of the optical sensor 24 emit light to the platen 25 side, reads the sensor output of the optical sensor 24, detects the edge part Eg1 in the home position side of the recording medium P in a position where the detection voltage changes from the value gp to the value g1 or g2, detects the edge part Eg2 in the retreat position side of the recording medium P in a position where the detection voltage changes from the value g1 or g2 to the value gp as shown in FIG. 5, calculates the width of the recording medium P, its position on the platen 25, etc. based on the detected positions of the edge parts Eg1 and Eg2, and records them in the RAM 82.

Subsequently, the medium information acquisition processing part Pr4 sets positions to form the pattern images on the recording medium P, that is, the pattern image formation positions, and positions to detect the pattern images formed on the recording medium P, that is, pattern image detection positions.

Next, the head drive processing part Pr1 forms the pattern images on the recording medium P. For that purpose, the head drive processing part Pr1 sends an instruction to the carriage drive processing part Pr3, and the carriage drive processing part Pr3 drives the carriage motor 22 to return the carriage 17 to the home position and afterwards move it from the home position side to the retreat position side. Then, the head drive processing part Pr1 forms the basic pattern images Pt1 in the above-mentioned pattern image formation positions in the outbound travel of the carriage 17, thereby forming the test patches Paj of the reference pattern image PA.

Also, the head drive processing part Pr1 sends an instruction to the carriage drive processing part Pr3, thereupon the carriage drive processing part Pr3 drives the carriage motor 22 to move the carriage 17 from the retreat position side to the home position side. Then, the head drive processing part Pr1 superimposes the basic pattern images Pt1 on the above-mentioned test patches Paj in the inbound travel of the carriage 17, thereby forming the test patches Pbj of the comparison pattern image PB. In this manner, the pattern images can be formed on the recording medium P.

Subsequently, the pattern image detection processing part Pr5 detects the pattern images formed on the recording medium P in the pattern image detection positions. For that purpose, the pattern image detection processing part Pr5 has the carriage drive processing part Pr3 drive the carriage motor 22 to move the carriage 17 from the home position side to the retreat position side, has the light emitting part 27 of the optical sensor 24 emit light onto the test patches Pbj, reads the detection voltages generated by the light receiving part 28, and records them in the RAM 82. In this case, light emitted onto the test patches Pbj by the light emitting part 27 consists of 5-10 beams, and the light receiving part 28 generates the detection voltages for the individual light beams, respectively.

In this case, as shown in FIG. 9, if the first timing to eject inks in the outbound travel of the carriage 17 and the second timing to eject inks in the inbound travel are made different, the test patches Pbj having different image densities from one another are formed. Then, the detection voltage generated by the light receiving part 28 for each of the test patches Pbj becomes high when the image density is low, and low when the image density is high.

Then, the image forming condition setting part Pr6 reads the detection voltages from the RAM 82, calculates the average value of the detection voltages for each of the test patches Pbj, and based on the first and second timings when the test patch Pbj having the highest average value was formed, calculates a correction value c for adjusting the timings to eject inks.

Among the test patches Pbj shown in FIG. 9, the test patch Pb6 has the lowest image density and the highest detection voltage, therefore the correction value ε becomes ε=+1τ.

Subsequently, the image forming condition setting part Pr6 records the correction value ε in the RAM 82.

Afterwards, when printing is performed, the image forming condition setting part Pr6 reads the correction value c from the RAM 82, and sets the correction value c as an image forming condition.

Then, the head drive processing part Pr1 adjusts the timings to eject inks from the recording heads Hdi according to the above-mentioned correction value c, thereby making it earlier by time 1τ.

Next, explained is the flow chart. S1: The medium information acquisition processing part Pr4 detects the edge parts Eg1 and Eg2 of the recording medium P. S2: The medium information acquisition processing part Pr4 sets the pattern image formation positions and the pattern image detection positions. S3: The head drive processing part Pr1 forms the pattern images on the recording medium P. S4: The pattern image detection processing part Pr5 detects the pattern images formed on the recording medium P in the pattern image detection positions. S5: The image forming condition setting part Pr6 calculates the correction value c for adjusting the timings to eject inks. S6: The head drive processing part Pr1 adjusts the timings to eject inks, and ends the process.

In this manner, in this embodiment, the image regions Er1 and the non-image regions Er2 are alternately formed in the pattern image, the longitudinal streaks Wh1 and Wh3 and the slant streaks Wh2 formed on the recording surface of the recording medium P are not excessively covered with the image regions Er1, or the longitudinal streaks Wh1 and Wh3 and the slant streaks Wh2 mentioned above are not excessively exposed. Therefore, the sensor output of the optical sensor 24 becomes stable, thereby the pattern image can be accurately detected.

As a result, the timings to eject inks from the recording heads Hdi can be accurately adjusted, thereby the image quality can be improved.

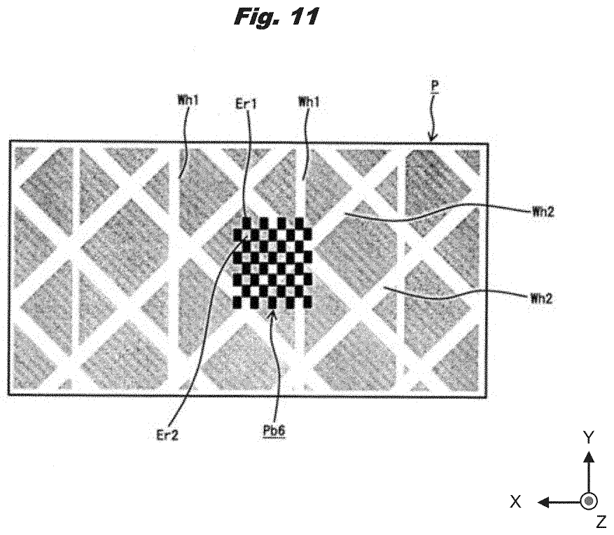

FIG. 11 is a diagram showing the relationship between the recording surface of the recording medium and a test patch in the embodiment of this invention.

In the figure, indicated as P is the recording medium made of the retroreflective medium, Wh1 are the longitudinal streaks, Wh2 are the slant streaks, Pb6 is a test patch of the pattern image PB (FIG. 9), Er1 are image regions, and Er2 are non-image regions.

In this case, in each column of the test patch Pb6, the image regions Er1 and the non-image regions Er2 are alternately formed in the sub scanning direction, thereby the longitudinal streaks Wh1 are not excessively covered or excessively exposed.

Therefore, the pattern image can be accurately detected.

Next, explained are other examples of the basic pattern image.

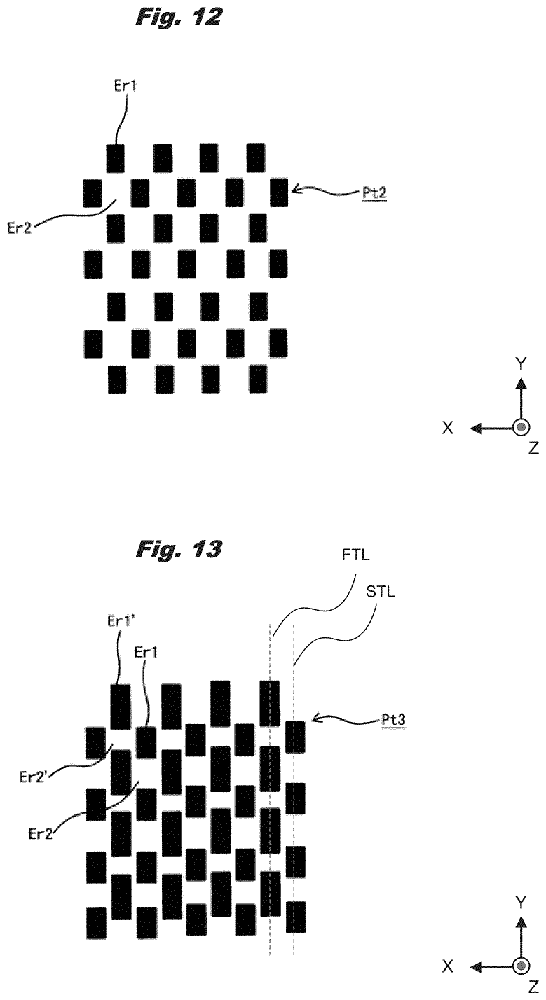

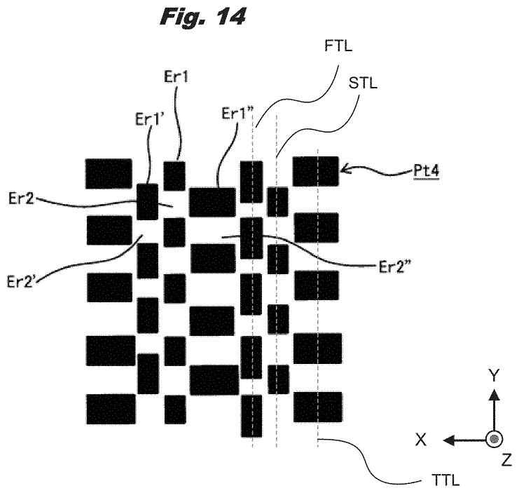

FIG. 12 is the first diagram showing another example of the basic pattern image in the embodiment of this invention, FIG. 13 is the second diagram showing another example of the basic pattern image in the embodiment of this invention, and FIG. 14 is the third diagram showing another example of the basic pattern image in the embodiment of this invention.

In the figures, indicated as Pt2-Pt4 are the basic pattern images, Er1 are image regions, and Er2 are non-image regions.

In the basic pattern image Pt2, the image regions Er1 are formed separated from one another in the main scanning direction and the sub scanning direction.

By the way, when the image regions Er1 are formed by ejecting inks, depending on the kinds of inks, the kind of the recording medium P, etc., if inks adhering to the recording medium P bleed, and corners of the image regions Er1 become connected, the image regions Er1 may excessively cover the longitudinal streaks Wh1.

In the basic pattern image Pt2, because the image regions Er1 are formed separated from one another, the image regions Er1 do not excessively cover the longitudinal streaks Wh1, thereby the pattern image can be accurately detected.

Also, in the basic pattern image Pt3, the image regions Er1, and image regions Er1′ that are different from the image regions Er1 in length in the sub scanning direction, that is, elongated in the sub scanning direction, are alternately formed in the main scanning direction. Then, the non-image regions Er2, and non-image regions Er2′ that are different from the non-image regions Er2 in length in the sub scanning direction, that is, shortened in the sub scanning direction, are alternately formed in the main scanning direction.

In the embodiment, test lines, which are composed with the image regions and the non-image regions, extend in the sub scanning direction (Y). First test lines FTL, of which a length determined in the sub scanning direction, is disposed next to second test lines STL, of which a length in the sub scanning direction is different from that of the first test lines. In FIG. 13, exemplarily only one first test line and one second test line are denoted with references. The second test lines are next to the first test lines. These first and second test lines are alternatively arranged in parallel in the main scanning direction (X). In FIG. 14, three different types of test lines (first, second and third test lines) are illustrated. When a length in the main scanning direction (X) is termed as a width, the width of the third test line(s) TTL is larger than those of the first and second test lines.

By forming the basic pattern image in this manner, the longitudinal streaks Wh1 and the slant streaks Wh2 are not excessively covered or excessively exposed, thereby the pattern image can be accurately detected.

Then, in the basic pattern image Pt4, the image regions Er1, the above-mentioned image regions Er1′, and image regions Er1″ that are different from the image regions Er1 and Er1′ in length in the main scanning direction, that is, elongated in the main scanning direction, are alternately formed in the main scanning direction. Then, the non-image regions Er2, the above-mentioned image regions Er2′, and non-image regions Er2″ that are different from the non-image regions Er2 and Er2′ in length in the main scanning direction, that is, elongated in the main scanning direction, are alternately formed in the main scanning direction.

By forming the pattern image in this manner, not only that the longitudinal streaks Wh1 and the slant streaks Wh2 are not excessively covered or excessively exposed, but also that a plurality of thin white lateral streaks extending laterally (in the main scanning direction) are not excessively covered or excessively exposed. Therefore, the pattern image can be accurately detected.

In this embodiment, in order to form dots in the same position between the outbound travel and the inbound travel of the carriage 17, the timings to eject inks from the recording heads Hdi are adjusted. Instead, the carrying amount when the recording medium P is carried by a certain distance in the sub scanning direction can be adjusted.

In that case, when forming the comparison pattern image PB on the recording medium P, the test patches Pbj are formed with slightly different carrying amounts of the recording medium P. Then, the comparison pattern image PB is detected by the optical sensor 24, and based on the carrying amount when a test patch having the lowest image density among the test patches Pbj was formed, the carrying amount of the recording medium P in the sub scanning direction is adjusted.

In this embodiment, the inkjet printer 10 is explained. However, this invention can be applied to image forming apparatuses such as copiers, facsimile machines, and multifunction peripherals.

Note that this invention is not limited to the above-mentioned embodiment, but various modifications can be made based on the purpose of this invention, and they are not excluded from the scope of this invention.

What is claimed is:

1. An image forming apparatus, comprising:
(a) recording heads that are mounted on a carriage,
(b) a pattern image formation processing part that forms a test pattern image on a recording medium by using the recording heads, wherein a position of the test pattern on the recording medium is defined as a pattern image formation position,
(c) an optical detection part that
emits light onto the recording medium,
receives reflection light that is reflected on the recording medium, and
generates a sensor output in correspondence with the reflection light,
(d) a pattern image detection processing part that detects the test pattern image formed at the pattern image formation position using the optical detection part, generating a detection result, and
(e) an image forming condition setting part that sets an image forming condition based on the detection result of the test pattern image, wherein
(f) dense parts and pale parts are alternately formed in the test pattern image.

2. The image forming apparatus according to claim 1, further comprising:
a carriage that is arranged freely movable in a linear direction, which is defined in a main scanning direction,
a carriage drive processing part that moves the carriage by driving a drive part for moving the carriage.

3. The image forming apparatus according to claim 2, wherein
(a) the test pattern image consists of a plurality of test patches formed next to one another in the main scanning direction, and
(b) the pattern image formation processing part forms the test pattern image by making a first timing to eject inks from the recording heads in an outbound travel of the carriage and a second timing to eject inks from the recording heads in an inbound travel of the carriage different, wherein the carriage is configured to reciprocate in the main scanning direction, one movement along the main scanning direction being defined as the outbound travel and the other movement, which is in an opposite direction from the outbound travel, being defined as the inbound travel.

4. The image forming apparatus according to claim 1, wherein
based on the sensor output that is generated when the optical detection part is detected the test pattern image, the image forming condition setting part calculates a correction value for adjusting a timing to eject inks from the recording heads to form an image on the recording medium and sets the timing as an image forming condition.

5. The image forming apparatus according to claim 1, wherein
(a) the dense parts are image regions that are formed by ejecting inks, and
(b) the pale parts are non-image regions that are formed by not ejecting any ink.

6. The image forming apparatus according to claim 2, wherein
the dense parts and the pale parts are alternately formed in a sub scanning direction that is perpendicular to the main scanning direction on the recording medium.

7. The image forming apparatus according to claim 5, wherein
the dense parts and the pale parts are alternately formed in the main scanning direction.

8. The image forming apparatus according to claim 6, wherein
the dense parts are aligned in the sub scanning direction, making a plurality of test lines, each of the test lines extending in the sub scanning direction and all of the test lines being arranged in parallel in the main scanning direction, and
lengths of the dense parts are determined in the sub scanning direction,
the length of the dense parts, which belongs to first test lines, is different from the length of the dense parts, which belongs to second test lines, and
the first test lines and the second test lines are alternatively arranged in the main scanning direction.

9. The image forming apparatus according to claim 8, wherein
the lengths of the dens parts in the sub scanning direction are substantially uniform.

10. The image forming apparatus according to claim 5, wherein
the dense parts are aligned in the sub scanning direction, making a plurality of test lines, each of the test lines extending in the sub scanning direction and all of the test lines being arranged in parallel in the main scanning direction, and
lengths and widths of the dense parts are respectively determined in the sub scanning direction and the main scanning direction,
the length and the width of the dense parts, which belongs to first test lines, are different from the length and the width of the dense parts, which belongs to second test lines, and the first test lines and the second test lines are alternatively arranged in the main scanning direction.

11. The image forming apparatus according to claim 1, wherein
streaks are formed on the recording medium due to reflection characteristics of its recording surface.
